(19) United States
(12) Patent Application Publication
(10) Pub. No.: US 2018/0003249 A1
(43) Pub. Date: Jan. 4, 2018

(54) Disc Brake for a Utility Vehicle

(71) Applicant: KNORR-BREMSE Systeme fuer Nutzfahrzeuge GmbH, Muenchen (DE)

(72) Inventor: Alexander ASEN, Eichendorf (DE)

(21) Appl. No.: 15/625,576

(22) Filed: Jun. 16, 2017

Related U.S. Application Data
(63) Continuation of application No. PCT/EP2015/080154, filed on Dec. 17, 2015.

(30) Foreign Application Priority Data
Dec. 19, 2014 (DE) 10 2014 019 112.5

(51) Int. Cl. F16D 55/2265; F16D 55/227; F16D 65/00

(52) U.S. Cl. CPC F16D 55/22655; F16D 65/0087; F16D 55/227; F16D 65/0075; F16D 2200/0056

(57) ABSTRACT

A disc brake for a utility vehicle is provided. The brake caliper of the disk brake is configured to be mounted in an axially-displaceable manner on a stationary brake carrier by two fastening elements. The two fastening elements are plain bearings arranged in respective bores of the brake caliper, one as a locating bearing and the other as a floating bearing. The floating bearing includes a sliding bush made from a plastic, in particular an elastomer, and a guide rod configured to be connected to the brake carrier is mounted. The sliding bush is held on the guide rod secured against axial displacement between the guide rod and the inner wall of the respective brake caliper bore. The sliding bush is configured to carry a lubricant on its circumferentially outer surface and has sealing lips projects radially outward that bear against the inner wall of the respective bore.

### CROSS REFERENCE TO RELATED APPLICATIONS

This application is a continuation of PCT International Application No. PCT/EP2015/080154, filed Dec. 17, 2015, which claims priority under 35 U.S.C. §119 from German Patent Application No. 10 2014 019 112.5, filed Dec. 19, 2014, the entire disclosures of which are herein expressly incorporated by reference.

### BACKGROUND AND SUMMARY OF THE INVENTION

The invention relates to a disk brake for a utility vehicle, and in particular an arrangement for mounting a disk brake caliper.

A brake caliper (also called a sliding caliper) of a disk brake of the generic type is held by fastening elements on a vehicle-side, that is to say stationary, brake carrier.

To this end, guide rods are fastened to the brake carrier, in particular by way of being screwed in. The guide rods are guided on the other side in plain bearings of the brake caliper in such a way that the brake caliper can be displaced axially during a braking operation relative to a brake disk. The brake caliper is held on an axle of the vehicle such that it is secured against rotation.

One of the plain bearings is configured as a locating bearing with a low sliding play and mainly serves for axial guidance of the brake caliper, the bearing play being kept as low as possible.

In contrast, the other plain bearing, as a floating bearing, has a greater bearing play owing to its function, since tolerance compensation and thermally induced expansions are also to be taken into consideration in addition to the axial guidance.

Due to the greater bearing play, rattling noises can be produced during driving operation. In the known disk brake, a sliding bush which consists of plastic, in particular an elastomer, and in which the guide rod is mounted axially displaceably, is used to prevent or damp said rattling noises.

Said sliding bush is held in a bearing bush made from metal, usually from sheet steel, such that it is secured against displacement. The bearing bush is pressed into a bore of the brake caliper and is held in a frictionally locking manner therein as a result, the sliding bush and the bearing bush being constituent parts of a guide bush.

A stop ring is used as a further element of the guide bush in order to limit the insertion when the guide bush is pressed into the bore of the brake caliper. The stop ring bears against a shoulder of the bore of the brake caliper. Moreover, the stop ring protects the sliding bush against damage by limiting the damping travel, thereby avoiding damage of the caliper-side bore as a result of contact of the guide bush.

However, the provision of the guide bush and its assembly can be realized only with considerable complexity, high production costs due to the relatively large number of constituent parts of the guide bush, including the abovementioned metallic bearing bush, the sliding bush made from plastic which is connected to it, and the stop ring.

In order to obtain a press fit for the guide bush and therefore to ensure securing against displacement in the brake caliper, relatively precise machining both of the bearing bush and of the brake caliper-side bore is required.

The abovementioned shoulder of the bore, against which the stop ring bears, can likewise be produced only with corresponding production complexity, that is to say the bore has to be configured as a stepped bore.

The costs of the assembly of the guide bush also do not correspond to the specifications for cost-optimized machining.

The invention is based on the object of developing a disk brake of the generic type in such a way that it is simplified in design terms and its production and assembly becomes simpler and therefore less expensive.

The provision of a guide bush can be dispensed with completely as a result of the invention. Instead, the sliding bush which is required for the typical tasks of a floating bearing is a constituent part of the guide rod, which results in a whole range of advantages. These include first of all the simplified production of the floating bearing, since essentially only the guide rod and the sliding bush, which is held thereon such that it is secured against displacement, have to be produced.

This preferably takes place by way of encapsulation of the guide rod with plastic in order to configure the sliding bush, the guide rod having a circumferential groove in accordance with one embodiment of the invention, the width of which circumferential groove corresponds to the desired width of the sliding bush. The walls which delimit the groove laterally form a stop for securing against displacement, and at the same time serve to prevent crushing of the sliding bush.

According to a further embodiment, grease grooves are provided on the outer side of the sliding bush. The grease grooves preferably run obliquely in a manner known per se and serve to receive grease, in order to make possible a low-friction displacement of the brake caliper on the sliding bush.

On the end side, the grease grooves are delimited, that is to say closed on the end side, by way of at least one circumferential sealing lip. The sealing lip firstly prevents discharge of the grease, and secondly protects the grease grooves against the penetration of dirt.

In addition to the extremely inexpensive production of the floating bearing, which also includes substantially simpler machining of the brake caliper-side bore, in particular since narrow tolerances no longer have to be maintained, the assembly complexity of the floating bearing overall is likewise reduced considerably, that is to say is possible in a very short time. A contribution is made to this, above all, by the fact that the guide rod with an integrated sliding bush merely has to be pushed into the brake caliper-side bore or the brake caliper has to be pushed onto the guide rod which has already been connected to the brake carrier.

All in all, the invention leads to a remarkable cost saving during the production of the disk brake. Here, the functionality, as exists in the case of a disk brake in accordance with the prior art, remains completely preserved.

As a result of the radial projection of the sliding bush with respect to the guide rod, the tasks which are assigned to the floating bearing are met in an unrestricted manner even in the case of the novel floating bearing. They include, in particular, the avoidance of rattling noises, since the sliding bush damps vibrations which occur and prevents the guide rod from coming into contact with the wall of the brake caliper-side bore.

Moreover, production-induced tolerances are also absorbed in the novel configuration by way of the sliding bush, with the result that the guide rod which is fitted with the sliding bush assumes the complete and unrestricted function of a floating bearing.

The width of the sliding bush can be selected freely and is defined merely by the stipulation of a sufficient contact with the wall of the brake caliper-side bore, which contact is in turn defined by a sufficient functionality.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a disk brake in accordance with the present invention in a diagrammatic plan view.

FIG. 2 shows a part of the FIG. 1 disk brake in an exploded illustration.

FIG. 3 shows a detail of the FIG. 1 disk brake in a sectioned side view.

FIG. 4 shows an enlarged detail, in accordance with the marking “B” in FIG. 3.

FIGS. 5A-5C show a part of the FIG. 1 disk brake guide rod in different views.

### DETAILED DESCRIPTION OF THE DRAWINGS

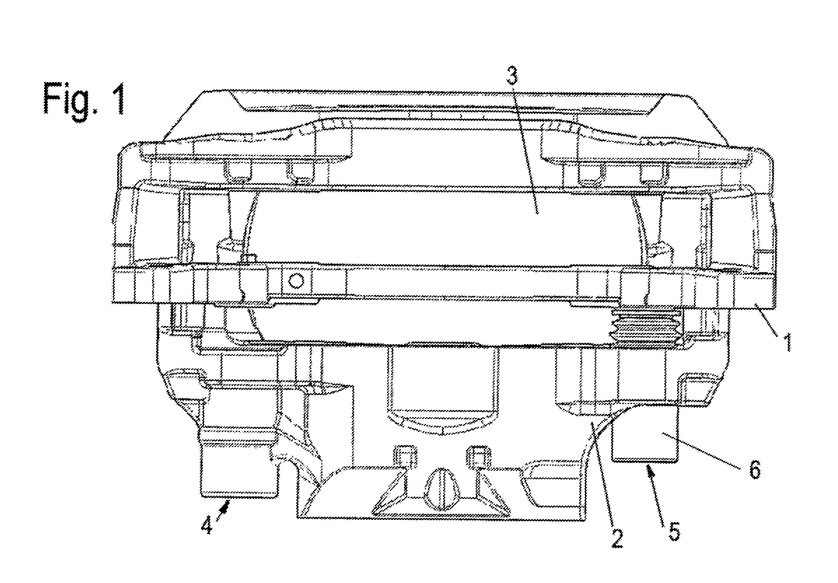

FIG. 1 shows a disk brake for a utility vehicle, which disk brake has a brake caliper 2 in its basic construction, which brake caliper 2 encloses in the space denoted by reference number 3 a brake disk (not shown). The brake caliper 2 is fastened to an axle (not shown) of the utility vehicle such that it is secured against rotation.

The brake caliper 2 is arranged on a stationary brake carrier 1 of the utility vehicle such that it can be displaced axially, in relation to the brake disk.

Two fastening elements are provided which have in each case one guide rod 6 which is connected to the brake carrier 1 and is fastened to the brake carrier 1 by a bolt (not shown). Here, one fastening element is configured as a locating bearing 4 and the other is configured as a floating bearing 5.

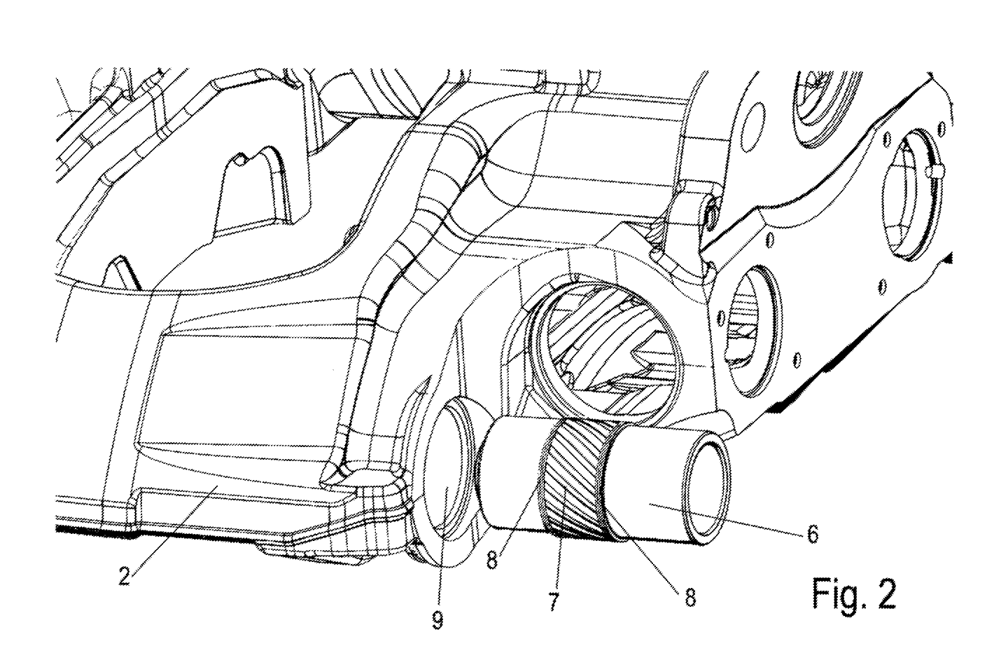

In order to mount the guide rod 6, that is to say for axial guidance of the brake caliper 2, the floating bearing 5 has a sliding bush 7 made from a plastic, preferably an elastomer, which is held on the guide rod 6 such that it is secured against displacement according to the invention, as can be seen particularly clearly in FIG. 2. Said figure shows the guide rod 6 with the sliding bush 7 immediately before assembly.

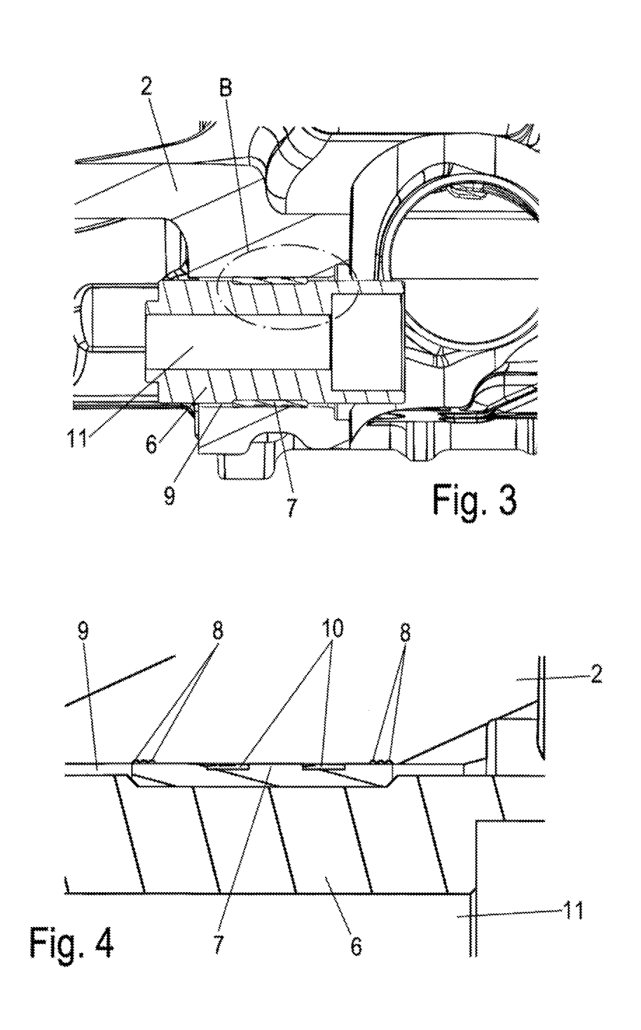

FIGS. 3 and 4 show a part detail of the brake caliper 2 with an assembled guide rod 6. It can be seen in said figures that the sliding bush 7 projects radially with respect to the guide rod 6 and bears against the wall of the brake caliper-side bore 9.

A circumferential groove 12, on the walls of which the sliding bush 7 is supported, is made in the shell of the guide rod 6 in order to secure the sliding bush 7 against axial displacement on the guide rod 6 which otherwise has a stepped bore 11 for receiving said bolt for connection to the brake carrier 1.

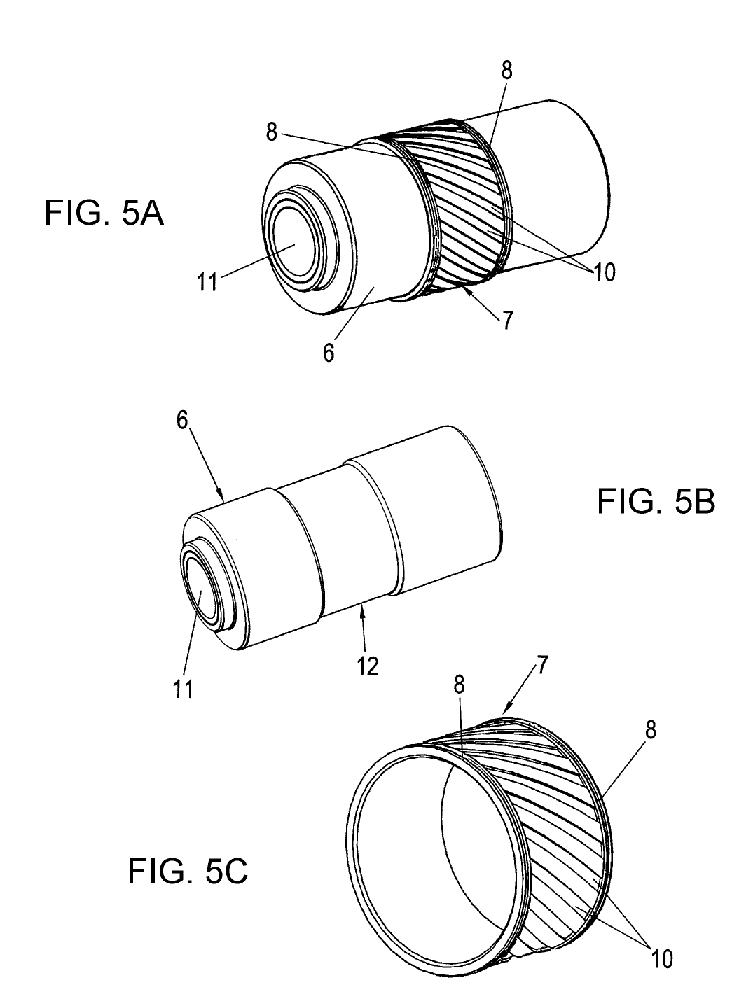

FIG. 5B shows the guide rod 6 and FIG. 5C shows the sliding bush 7, in each case as a detail, whereas FIG. 5A illustrates the guide rod 6 with an attached sliding bush 7.

It can be seen clearly therein and in FIG. 4 that the sliding bush 7 has a multiplicity of grease grooves 10 on its outer side which faces the wall of the bore 9, which grease grooves 10 run obliquely in relation to a center axis of the sliding bush 7. Here, said grease grooves 10 are distributed uniformly over the circumference.

The grease grooves 10 are closed on the end side by way of circumferential sealing lips 8, of which a plurality are integrally formed on each side such that they lie next to one another.

Said sealing lips 8 serve both to prevent a discharge of grease from the grease grooves 10 and to seal the latter in order to avoid penetration of dirt.

As has already been mentioned, the sliding bush 7 is expediently produced by way of encapsulation of the guide rod 6 in the region of the groove 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A disk brake for a utility vehicle, comprising:
a brake caliper configured to straddle a brake disk and to be axially displaceable parallel to a rotation axis of the brake disk when in an installed position on a stationary brake carrier;
two fastening elements of the brake caliper configured to support the brake caliper on the stationary brake carrier, each fastening element being a plain bearing configured to be arranged in a respective bore of the brake caliper,
wherein
a first one of the two fastening elements is configured as a locating bearing and a second one of the two fastening elements is configured as a floating bearing,
the floating bearing includes a sliding bush configured to be received in the respective brake caliper bore and a guide rod configured to be connected to the stationary brake carrier,
the sliding bush is held against axial displacement on the guide rod between an outer circumference of the guide rod and an inner wall of the respective brake caliper bore.

12. The disk brake as claimed in claim 11, wherein
the guide rod includes a circumferential groove configured to receive the sliding bush.

13. The disk brake as claimed in claim 12, wherein
an axial end of the sliding bush bears on an axial end side of the groove.

14. The disk brake as claimed in claim 13, wherein
the sliding bush is formed of at least one of a plastic and an elastomeric material, and
at least a portion of guide rod is encapsulated by the sliding bush material.

15. The disk brake as claimed in claim 14, wherein
an outer side of the sliding bush which faces the inner wall of the respective bore includes grooves configured to receive grease.

16. The disk brake as claimed in claim 15, wherein
the grease grooves are arranged obliquely relative to the a longitudinal axis of the sliding bush.

17. The disk brake as claimed in claim 16, wherein
the grease grooves are arranged at an identical spacing from one another.

18. The disk brake as claimed in claim 15, wherein
the grease grooves are closed on an axial end side.

19. The disk brake as claimed in claim 15, wherein
the sliding bush includes at least two circumferential sealing lips configured to bear against the inner wall of the respective bore, and
two of the at least the two circumferential sealing lips are each formed integrally at respective axial end regions of the sliding bush.

20. The disk brake as claimed in claim 19, wherein
the at least two circumferential sealing lips includes a plurality of sealing lips arranged adjacent to one another on the sliding bush.
